(19) United States
(12) Patent Application Publication
(10) Pub. No.: US 2007/0070849 A1
(43) Pub. Date: Mar. 29, 2007

(54) Optical disk discriminating method and optical disk apparatus utilizing the same therein

(76) Inventors: Toshio Saitoh, Matsudo (JP); Shigeki Yamazaki, Matsudo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/494,712

(22) Filed: Jul. 28, 2006

(30) Foreign Application Priority Data
Sep. 27, 2005 (JP) 2005-279952

(51) Int. Cl. G11B 7/00

(52) U.S. Cl. 369/53.22

(57) ABSTRACT

Within an optical disk apparatus for recording or reproducing information onto/from an optical disk 1, by irradiating one three (3) laser beams upon information recording surface RS thereof, each having wavelength different from each other, selectively, through a 3-wavelengths compatible objective lens 31, according to a method for discriminating a kind of optical disk loaded therein, focus sweep is conducted upon the optical disk loaded, in a descending order of distance between the position of the objective lens when it focus the laser beam upon the information recording surface and the disk surface DS, so as to detect a time between the disk surface DS and the information recording surface RS on the optical disk, from a reflection light obtained, and thereby discriminating the kind of the optical disk upon basis of the time between the reflections detected in the above.

### BACKGROUND OF THE INVENTION

The present invention relates to an optical disk apparatus for reproducing information from various kinds or types of optical disks, including such as, CD (a Compact Disk), DVD (®: a Digital Versatile Disk), and further next-generation DVDs therein, for example, and in particular, it relates to an optical disk discriminating method for determining a kind or type of the optical disk loaded therein, within such the apparatus, and to an optical disk apparatus utilizing that therein, as well.

Optical disks, i.e., disc-like information recording media, are widely used, as information recording media known of non-contact, having a large memory capacity, and low-costs, as well as, enabling data access at high-speed, in particular, for recording digital audio data and/or digital video data thereon, and further as a data recording medium for a personal computer. Furthermore, in recent years, attention is paid upon so-called, the next-generation DVD, such as, HD-DVD and BD (®), etc., as being an optical information recording medium for enabling recording/reproducing of information at higher density. Accompanying with this, demands are made upon optical disk apparatuses, also enabling to record/reproduce information onto/from such various information recording media, and in such case, it is necessary for the apparatus to discriminate the optical disk, which is loaded into that apparatus, with certainty.

For example, in the following Patent Document 1 is proposed or disclosed an optical disk apparatus of being 3-wavelengths operable, which has objective lenses, each being independent on the various kinds or types of optical disks, respectively, including various kinds of CDs, DVDs, and further in addition thereto, the optical disks of high density, being accessible with using a light beam of blue or violaceous color. However, this conventional art discloses therein a method for discriminating disks from the “S” shaped waveform of a focus error signal, by using a laser beam (laser beam having wavelength of 780 nm) for CD therein, at first, so that it is possible to let the focal distance of the objective lens to be longest and the distance between the objective lens and the disk surface to be largest, for the purpose of discriminating the optical disk, which is loaded into the apparatus.

Also, in the following Patent Document 2, for example, is disclosed a method for conducting the disk discrimination, judging from the “S” shaped waveform of a focus error signal and an amount of reflection light, with using a spherical aberration generating portion (i.e., a beam expander) which is installed in an optical head of being 3-wavelengths operable.

In addition thereto, for example, the following Patent Document 3 discloses therein a method for discriminating the optical disk loaded upon detection results thereof; i.e., a laser beam from a laser diode for use of CD is irradiated upon the disk, and as a result thereof, detections are made on reflection lights with using various kinds of detectors (i.e., for uses of CD, DVD and HD-DVD).

[Patent Document 1] Japanese Patent Laying-Open No. 2004-311004 (2004);

[Patent Document 2] Japanese Patent Laying-Open No. 2004-111028 (2004); and

[Patent Document 3] Japanese Patent Laying-Open No. 2004-152452 (2004).

### BRIEF SUMMARY OF THE INVENTION

By the way, for the optical disk apparatus of being 3-wavelengths operable, enabling to record/reproduce information on such various kinds of optical disks as was motioned, with using a laser beam corresponding to each thereof, it is strongly demanded to achieve small-sizing, in particular, upon the optical head thereof, to be installed within said apparatus, for achieving the small-sizing of the apparatus. As a means for satisfying such demand, an objective lens being compatible with 3-wavelengths is already known, and it is now entering into a stage of practical use thereof.

However, this 3-wavelengths compatible objective lens differs, comparing to the combination of an objective lens for BD and a lens compatible with DVD and CD, in particular, in the focal distances thereof, with respect to wavelengths of the respective laser beams (i.e., a laser beam for CD (wavelength: 780 nm), a laser beam for DVD (wavelength: 650 nm), and a laser beam for BD (wavelength: 405 nm).

In this manner, since the 3-wavelengths compatible objective lens, enabling to achieve small-sizing of the optical head, differs in the focal distance for each wavelength, therefore, there is a drawback that the objective lens may collide on the optical disk during the disk discrimination, which is conducted when the optical disk in loaded into the apparatus, in particular, when applying such 3-wavelengths compatible objective lens into the optical disk apparatus.

In more details, within the optical disk apparatus, installing such the 3-wavelengths compatible objective lens therein, the distance between the objective lens and the disk surface comes to be about 0.7 mm, with respect to the laser beam of wavelength 405 nm, and 0.2 mm, with respect to the laser beam of wavelength 780 nm, when focusing the laser beam upon the information recording surface of the disk; thus, the distances are reversed comparing to those of the conventional arts (i.e., the Patent Documents 1 and 2) mentioned above, and for this reason, it is difficult to avoid the collision between the objective lens and the optical disk, according to the disk discrimination method disclosed in the conventional arts, within the optical disk apparatus, installing such the 3-wavelengths compatible objective lens therein, and thereby brining about a new problem in relation to avoiding of such collision between the objective lens and the optical disk.

Also, as be mentioned below, in case when trying to made the discrimination with using the laser beam for CD, as was mentioned in the conventional art (i.e., the Patent Document 3), because of low resolution power, it is impossible to discriminate the reflection upon the information recording surface of BD from that upon the surface thereof; therefore, there is possibility that discrimination cannot be made correctly upon the kind of the optical disk.

Then, according to the present invention, accomplished by taking the drawbacks in the conventional arts mentioned above into the consideration thereof, an object thereof is to provided an optical disk discriminating method, within an optical disk apparatus installing such the 3-wavelengths compatible objective lens therein, for enabling discrimination of an optical disk therein, with certainty, but without collision between that objective lens, and further to provide an optical disk apparatus applying such the method therein.

For accomplishing the object mentioned above, according to the present invention, firstly there is provided a method for discriminating a kind of optical disk loaded therein, within an optical disk apparatus for recording or reproducing information onto/from said optical disk, by irradiating a light beam among plural numbers of laser beams generated from a light radiation source, each having wavelength different from each other, selectively, through a common objective lens upon an information recording surface of said optical disk, comprising the following steps of: conducting focus sweep through said objective lens, upon said optical disk loaded into said optical disk apparatus, with using a laser beam from said light radiation source; detecting a time between a disk surface and said information recording surface on said optical disk, from a reflection light which is obtained as a result of said focus sweep; and discriminating the kind of said optical disk loaded into said optical disk apparatus, upon basis of the time between the reflections detected in the above.

Also, according to the present invention, within the method for discriminating a kind of optical disk, as described in the above, preferably, discrimination of kind is executed, sequentially, upon said optical disk loaded into said optical disk apparatus, in descending order of distance defined between a position of said objective lens when the laser beam from said light radiation source is focused upon the information recording surface thereof through said objective lens and the disk surface of said optical disk loaded therein, and in particular, said optical disk loaded into said optical disk apparatus is one of those, including at least a CD, a DVD, and a next-generation DVD therein. In that instance, preferably, the discrimination of kind of the optical disk is executed, in order that the next-generation DVD and then the DVD, and in that case, preferably, a laser beam of wavelength 405 nm and a laser beam of wavelength 650 nm are used when executing the discrimination of kind of the optical disk, in the order that the next-generation DVD and then the DVD. And, preferably, thereafter, it further comprises a step of conducting discrimination on that the optical disk loaded into said optical disk apparatus is the CD, with using a laser beam of wavelength 780 nm, after executing the discrimination of kind of the optical disk in the above, in the order that the next-generation DVD and then the DVD.

Further, according to the present invention, also for achieving the object mentioned above, there is provided an optical disk apparatus for recording or reproducing information onto/from an optical disk, comprising: a light radiation source for generating plural numbers of laser beams from, each having wavelength different from each other; a common objective lens for irradiating the plural numbers of laser beams through it, selectively, from said light radiation source upon an information recording surface of said optical disk; and a controller for conducting focus sweep through said objective lens, upon said optical disk loaded into said optical disk apparatus, with using a laser beam from said light radiation source, detecting a time between a disk surface and said information recording surface on said optical disk, from a reflection light which is obtained as a result of said focus sweep, and discriminating the kind of said optical disk loaded into said optical disk apparatus, upon basis of the time between the reflections detected In the above.

Further, according to the present invention, within the optical disk apparatus as described in the above, preferably, said controller execute discrimination of kind, sequentially, upon said optical disk loaded into said optical disk apparatus, in descending order of distance defined between a position of said objective lens when the laser beam from said light radiation source is focused upon the information recording surface thereof through said objective lens and the disk surface of said optical disk loaded therein, and also said light radiation source for generating the plural number of laser beams different in the wavelength thereof is able to generate a laser beam of wavelength 405 nm, a laser beam of wavelength 650 nm, and a laser beam of wavelength 780 nm therefrom. And, according to the present invention, within the optical disk apparatus as described in the above, said optical disk loaded into said optical disk apparatus is one of those, including at least a CD, a DVD, and a next-generation DVD therein, and said controller discriminates the kind of the optical disk, at least, in order that the next-generation DVD and then the DVD.

As was mentioned above, according to the present invention, there can be achieved a superior effect of enabling to provide an optical disk discriminating method for determining the kind of a disk loaded, upon basis of the time period from the reflection light upon the disk surface to the reflection light upon the information recording surface, and thereby achieving discrimination upon the optical disk loaded into an apparatus, easily and with certainty, but without causing collision between the objective lens. And, further, with applying such method therein, it is also possible to provide a small-size optical disk apparatus enabling to record/reproduce information onto/from various kinds of optical disks, with using a laser beam having a wavelength corresponding to each of them.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing the entire structures of an optical disk apparatus, according to an embodiment of the present invention;

FIG. 2 is a diagram for showing the detailed structures, in particular, in an inside of a pickup within the optical disk apparatus mentioned above;

FIGS. 3(a) to 3(c) are partial enlarged views for showing the structures of various kinds of the optical disks, upon which recording or reproducing is conducted within the optical disk apparatus mentioned above;

FIG. 4 is a view for showing the change on intensity of reflection light with respect to time, in case when conducting focus sweep by using the laser beam for BD, while loading BD into the apparatus, for explaining the principle of the optical discriminating method according to the present invention;

FIGS. 5(a) to 5(c) are views for explaining the distances between the disk surface DS of various kinds of optical disks and the surface of an objective lens under the condition of focusing the laser beam upon the information recording surface;

FIGS. 6(a) and 6(b) are views for showing the changes on intensity of reflection lights with respect to time, in cases when conducting focus sweep by using the laser beam for BD and when conducting focus sweep by using the laser beam for DVD, while loading DVD into the apparatus mentioned above;

FIG. 7 is a flowchart for showing an example of the optical disk discriminating method (discriminating process), according to the present intention, the principle of which was explained in the above; and

FIG. 8 is a flowchart for showing an example of the disk discriminating method (discriminating process) mentioned above, further, in particular.

### DETAILED DESCRIPTION OF THE INVENTION

Hereinafter, explanation will be made fully on embodiments according to the present invention, by referring to the attached drawings.

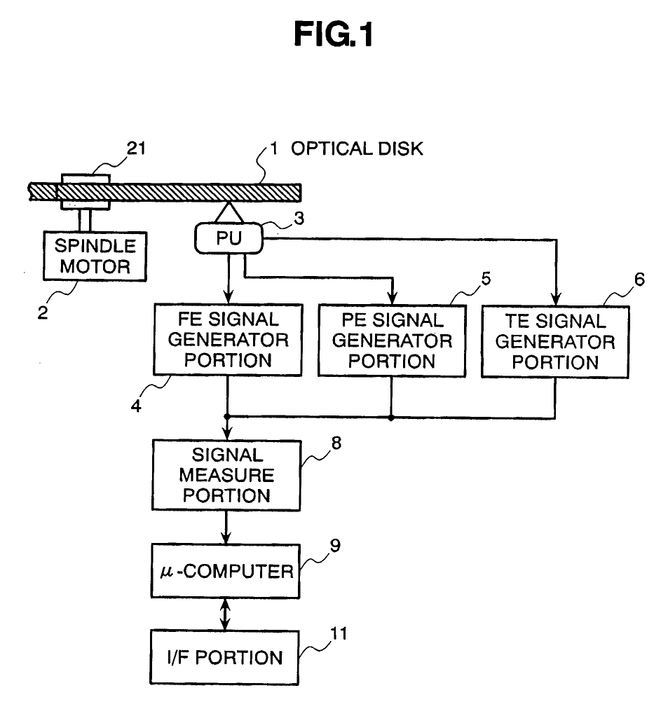

First of all, FIG. 1 shows the entire structures of an optical disk apparatus, according to an embodiment of the present invention. In this figure, the apparatus comprises a spindle motor 2, and on a turntable 21 attached at a tip of an output shaft thereof is mounted an optical disk 1, which will be recorded/reproduced by means of said apparatus, from various kinds or types of optical disks, to be rotationally driven at a predetermined speed. On the other hand, the detailed structures of which will be explained later, a pickup 3 irradiates a laser beam at predetermined intensity upon the optical disk 1 loaded, while a reflection light from the optical disk 1 is detected, to be converted into an electric signal. Upon basis of the detection signal from this pickup 3, a FE signal generator portion 4 generates a focus-error signal, a PE signal generator portion 5 a sum signal, and a TE signal generator portion 6 a tracking-error signal, respectively. Further, a signal measure portion 8 makes measurement upon level of each of those signals, so as to output it into a microcomputer 9 (hereinafter, “μ-computer”). This μ-computer 9 compares the level value of the detection signal from the signal measure portion 8 to a threshold value memorized in advance into a memory or the like (not shown in the figure), thereby carrying out the discrimination on a kind or type of the optical disk loaded or mounted, in a manner as will be explained in details thereof below, and also executing recording/reproducing of information onto/from the information recording surface of the optical disk loaded, but in a manner which was already known. Also, an I/F portion 11 in the figure transmits the contents of operation inputted by a user to the μ-computer 9, and also it outputs the information from the μ-computer 9 to a display portion.

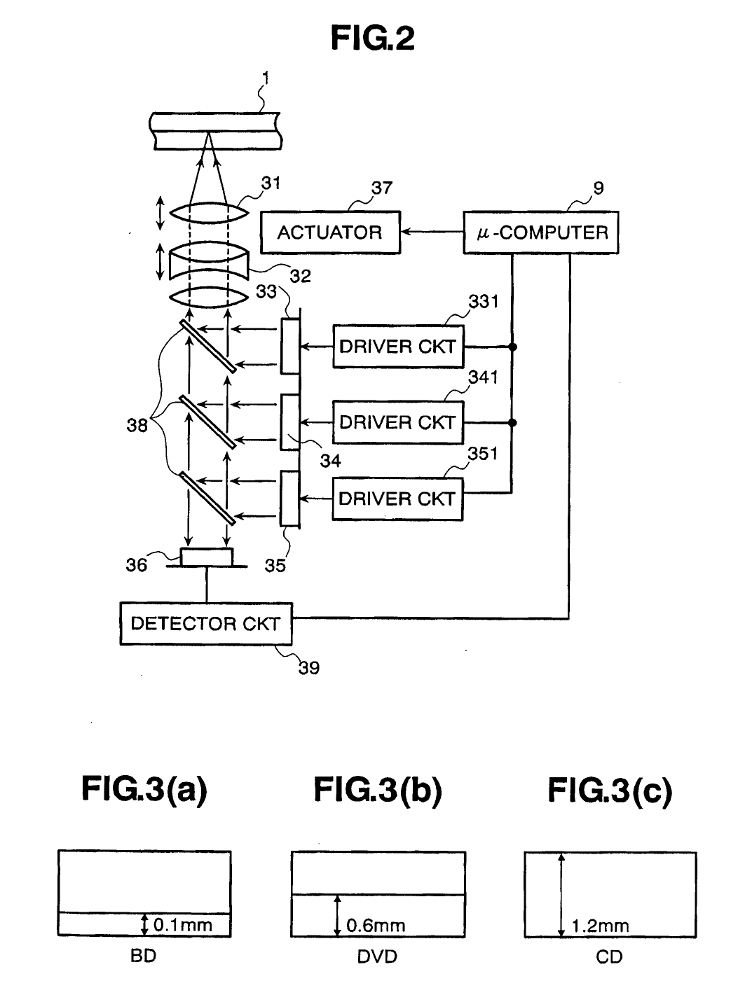

FIG. 2 attached here with is a view, in particular, for showing the detailed structures inside the pickup 3, within the optical disk apparatus, the entire structures of which were shown in the above. In this figure, the pickup 3 is disposed to be opposite to the surface of the said optical disk (i.e., the lower surface in this figure), and comprises an optic system, including an objective lens 31 and a beam expander 32 therein, lager generating elements 33, 34 and 35, each being made up with a laser diode or the like, for example, and further a light receiving element 36, being made up with a photodiode or the like, for example. Further, this objective lens 31 is of being 3-wavelengths compatible, as was mentioned above, and is movable into the direction perpendicular to the surface of the optical disk 1 (see an arrow in the figure), together with the beam expander 32 being made up with plural numbers of lenses, by means of an actuator 37 utilizing electromagnetic force, for example. Also, the laser generating elements 33, 34 and 35 mentioned above are driven on the light emission thereof, by the respective driver circuits 331, 341 and 351, responding to instructions supplied from the μ-computer 9; i.e., the element 33 for BD generates a laser beam of wavelength 405 nm, the element 34 for DVD a laser beam of wavelength 650 nm, and the element 35 a laser beam of wavelength 780 nm, respectively. Also, a reference numeral 38 in the figure depicts so-called a half-mirror (or, may be a polarization beam splitter), each for reflecting the laser beam generated from one of the laser generating elements 33-35, thereby irradiating it upon the surface of the optical disk 1 through the beam expander 32, as well as, for passing the reflection light upon the surface of the said optical disk 1 therethrough, so as to guide it onto the light receiving element 36. However, the reflection light sensed by the light receiving element 36 is detected within the detector circuit 39, thereby being converted into the electric signal.

Following to the above, explanation will be made about the principle of the optical disk discriminating method, according to the present invention. First, various kinds of optical disks, each being loaded into the apparatus and conducted with recording/reproducing therein, i.e., a next-generation DVD (for example, BD), DVD and CD are different from one another, in the distance “d”, from the disc-like disk surface (i.e., the lower surface in the figure), upon which the laser beam is irradiated, up to the information recording surface, on which data is recorded, as is shown in FIGS. 3(a) to 3(c) attached. Namely, “d” is (d=) about 0.1 mm (see FIG. 3(a)) on BD, “d” is (d=) about 0.6 mm (see FIG. 3(b)) on DVD, and “d” is (d=) about 1.2 mm (see FIG. 3(c)) on CD, respectively. In other words, on CD, the information recording surface is defined on an upper surface of the optical disk.

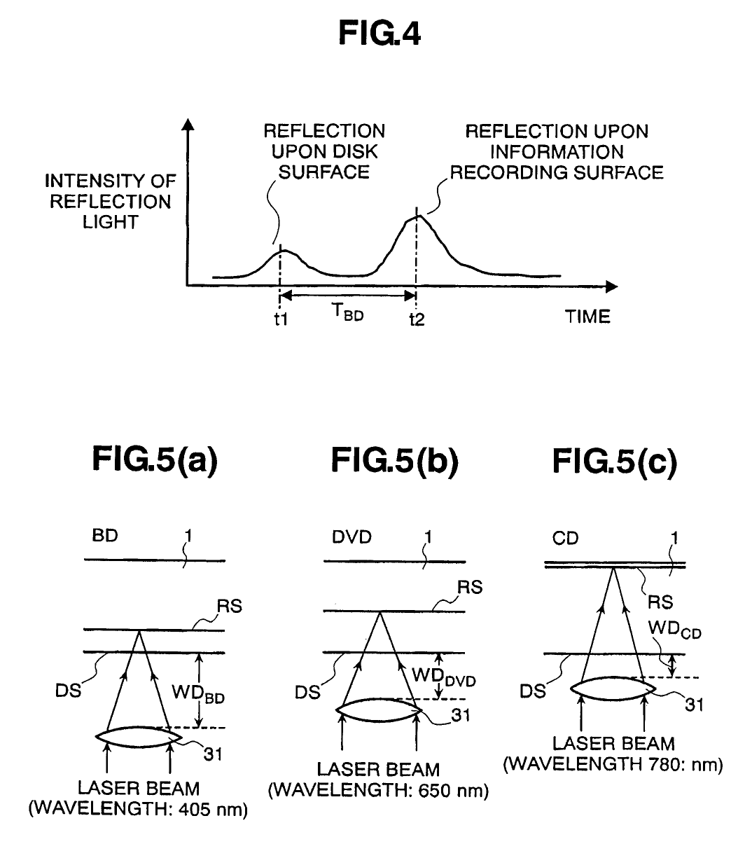

Then, change in intensity of the reflection light with respect to time is shown in FIG. 4 attached herewith, in case when loading the above-mentioned BD into the apparatus, so as to execute a focus sweep operation upon the said optical disk, with using the laser beam of blue or violaceous color (having wavelength 405 nm) for BD of the pickup, for example. Herein, the focus sweep operation is an operation of moving the 3-wavelengths compatible objective lens explained in the above (see the reference numeral 31 in FIG. 2) by means of a driving device thereof (i.e., the actuator 37 in FIG. 2) with respect to the surface of the disk 1, i.e., directing from a lower to an upper in the figure, moving it from the furthest position up to the disk surface, direction to the disk surface, continuously, at a predetermined speed. As a result thereof, as is shown in FIG. 4 mentioned above, the laser beam irradiated, first, upon the surface of disk is reflected (a first reflection (peak value); see the time “t1” in the figure) upon the surface of the optical disk loaded (i.e., the lowest surface in FIG. 3(a) mentioned above). Thereafter, it reaches on the information recording surface where the data is recorded, after elapsing a predetermined time period “T_{BD}”, and is reflected thereupon (a second reflection (peak value); see the time “t2” in the figure). Further, in this instance, the time period “T_{BD}” mentioned above comes to (“T_{BD}”)=0.1/V, from the moving velocity “V” of the objective lens during the focus sweep operation; i.e., it can be obtained, easily.

<Process 1>

Thus, as is apparent from the above, if the time distance between the first reflection and the second reflection is about “T_{BD}”, resulting from execution of the focus sweep operation mentioned above with applying the laser beam of wavelength 405 nm for BD therein, then it is possible to determine the optical disk loaded into the apparatus be the BD. However, in actually, by taking fluctuation in the distance (such as, unevenness) from the disk surface up to the information recording surface on the actual optical disk into the consideration thereof, a time “τ_{BD}” longer than (τ_{BD}>T_{BD}) is set up to be a slice level, for discriminating BD in the discrimination method which will be mentioned later.

Therefore, according to the present invention, it is possible to determine a kind of disk, which is loaded therein, by measuring the time period after observing or detecting the reflection light (i.e., the first reflection) upon the disk surface of the said optical disk, while irradiating the laser beam thereupon, up to when observing the reflection light upon the information recording surface (i.e., the second reflection).

By the way, in that instance, within the optical disk apparatus installing the 3-wavelengths compatible objective lens therein, in general, the optic system is so designed that the laser beam is focused at the position of 0.1 mm from the disk surface, in case when trying to discriminate it by using the laser beam of wavelength 405 nm for BD, as was mentioned above, for example. For this reason, if the focus sweep operation is executed, in particular, when loading CD therein, it brings about an anxiety that the objective lens collides on the disk surface, before it focuses the laser beam on the information recording surface thereof. Or, when trying to discriminate various kinds of the optical disks with using the laser beam of wavelength 780 nm for CD, but the resolving power thereof is low. For that reason, in particular, on BD, it is impossible to distinguish the reflection upon the information recording surface thereof (i.e., the first reflection) from the reflection on the surface thereof (i.e., the second reflection), and then, they may be observed to be one (1) reflection signal; therefore there is a possibility that the discrimination cannot be made, correctly.

In general, it is impossible to guarantee the reflection upon the information recording surface thereof, in case when the laser beams (i.e., a laser beam of wavelength 780 nm; a laser beam of wavelength 650 nm, and a laser beam of wavelength 405 nm) and the disks (i.e., CD; DVD; and BD) are combined to be used therein, in a manner different from one another. For that, depending upon the cases, but there is a case where the reflection light can be observed sparsely. Accordingly, as was mentioned previously (e.g., the technology disclosed in the Patent Document 3), if presuming that it would be determined BD when the reflection can be observed to be one with use of the laser beam of wavelength 780 nm for CD, however, undesirably, it may be also determined BD, erroneously, also when DVD is loaded in the place thereof, which also has very low reflectance (or reflectivity) to the laser beam of wavelength 780 nm for CD. Thus, it is dangerous to determine it be BD or DVD, indiscriminately, when discrimination cannot be made upon the reflection upon the information recording surface (i.e., the first reflection) and the reflection upon the surface thereof (i.e., the second reflection), so that only one reflection can be observed.

Also, within the optical disk apparatus installing the 3-wavelengths compatible objective lens therein, the pickup thereof is constructed with, as shown in FIGS. 5(a) to 5(c), one (1) piece of the objective lens (see the reference numeral 31 in FIG. 2) and three (3) pieces of laser diodes (see reference numerals 33-35 in FIG. 2), and further, work distance (WD), defined between the disk surface “DS” and the pickup (in particular, the upper surface of the objective lens locating at the uppermost thereof) under the condition of focusing the laser beam upon the information recording surface “RS”, differs from one another, depending upon the kinds of disks; for example, it becomes narrow in the order, BD→DVD→CD (i.e., WD_{BD} (about 0.7 mm)>WD_{DVD} (about 0.5 mm)>WD_{CD} (about 0.2 mm). Thus, the above means that risk increases of colliding between the pickup (in particular, the objective lens thereof) and the disk surface.

Then, according to the present invention, being accomplished upon basis of the above-mentioned knowledge made by the inventors, it is achieved to make determination upon the kind of disk loaded, through measurement of the time from observation of the reflection light (i.e., the first reflection) upon the disk surface “DS” of the optical disk to that of the reflection light (i.e., the second reflection) upon the information recording surface “RS”, and also avoiding the collision (i.e., contact) of the pickup upon the disk surface when making the discrimination, with certainty, by making the discrimination on a kind of medium according to wideness of the work distance (WD) mentioned above (see FIG. 4). Thus, according to the present invention, within the optical disk apparatus installing the 3-wavelengths compatible objective lens therein, disk discrimination is executed, at first, upon BD having the smallest risk of collision between the objective lens and the disk surface, in other words, being largest in the work distance (WD) between the objective lens and the disk surf ace, under the condition of focusing the laser beam upon the information recording surface “RS” of disk. With doing so, determination will not executed first, therefore it is possible to avoid the collision between the objective lens and the disk surface, with certainty.

And, as was already shown in FIGS. 3(a) to 3(c) mentioned above, within the determination on whether the disk is BD or not, conducting the focus sweep while radiating the laser beam of wavelength 405 nm, using a fact that the work distance is 0.1 mm between the disk surface and the information recording surface on BD, i.e., being far smaller than those, 0.6 mm on DVD, and 1.2 mm on CD, the discrimination is made by detecting on whether the time difference falls within a predetermined time period (τ_{BD}), i.e., from appearance of the reflection light upon the disk surface of BD (the first reflection; at time “t1”) to appearance of the reflection light upon the information recording surface thereafter (the second reflection: at time “t2”). However, in this instance, the spherical aberration generating portion (i.e., the beam expander 32) is set at the position corresponding to BD, and therefore the reflection light from the information recording surface of BD can be detected, accurately. And, also the predetermined time period (τ_{BD}: a slice level) mentioned above is set at such a time period (or, a value), in an extent, that it is sufficient for determining the medium to be other than BD, since no reflection is generated upon the information recording surface even if elapsing the said time period, and further, however that the objective lens will not reaches to the disk surface of CD due to continuation of the focus sweep operation mentioned above. According to the present embodiment, those time periods are set up in the extents; for example, τ_{BD} is 15-30 ms (T_{BD}−2T_{BD}), τ_{DVD} 40-60 ms (T_{DVD}−1.5T_{DVD}), and τ_{CD} 80-100 ms (T_{CD}−1.25T_{CD}).

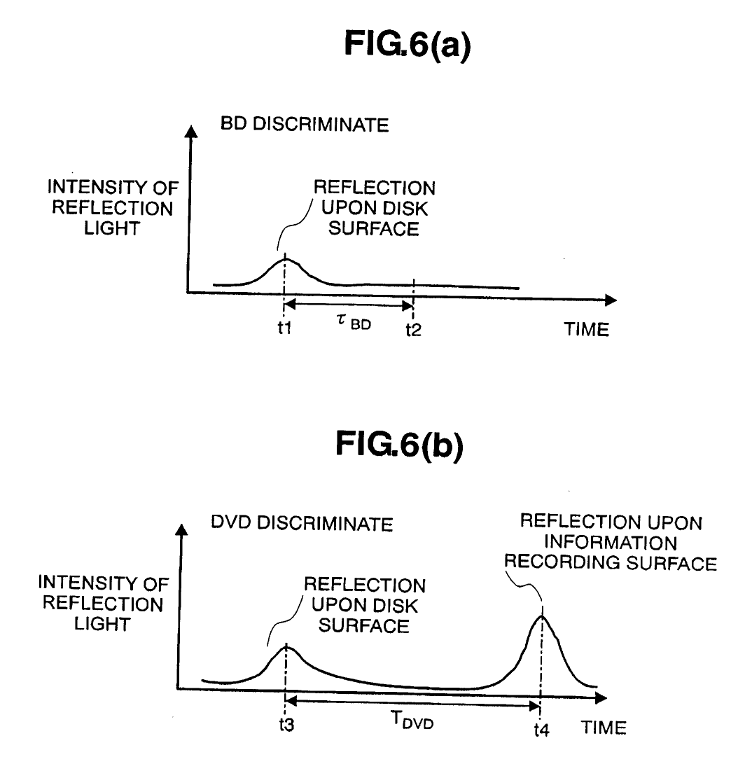

As was mentioned above, according to the present invention, first, it is possible to perform the discrimination <process 1> of BD with using the time “T” during which the two (2) reflection lights are obtained. However, explanation will be made upon the case where observation cannot be made upon the information recording surface (see the second reflection in FIG. 4) even after elapsing the predetermined time period (τ_{BD}: the slice level), as a result of the determination mentioned above, by referring to FIGS. 6(a) and 6(b). However, in this case, within the optical disk apparatus installing the 3-wavelengths compatible objective lens therein, the disk discrimination is conducted upon DVD, being smaller in the risk of generating collision between the objective lens and the disk surface, next to BD, in other words, being larger in the work distance (WD) between the objective lens and the disk surface next to BD.

FIG. 6(a) attached herewith shows change of the reflection light to time, in case when executing the focus sweep with use of the laser beam of wavelength 405 nm for BD, first, while loading DVD in the place of BD mentioned above. In this instance, although appearance of the reflection light upon the disk surface can be observed (i.e., the first reflection: at time “t1”), but thereafter, the reflection light upon the information recording surface (i.e., the second reflection) cannot be observed even after elapsing the predetermined time period (τ_{BD}: the slice level). Then, in case where no reflection light (i.e., the second reflection) appears after elapsing that predetermined time period (τ_{BD}), determination is made that the optical disk loaded is not BD, and then radiation of the laser beam of wavelength of 405 nm is stopped.

<Process 2>

Next, determination will be made on whether the optical disk loaded therein is DVD disk or not. In this instance, the spherical aberration generating portion (i.e., the beam expander 32) is changed the setup thereof corresponding to DVD, and at the same time, the position of the 3-wavelengths compatible objective lens is returned back into an outside of the surface of optical disk, again. With doing this, it is possible to avoid error recording caused due to instantaneous light radiation of the laser beam of wavelength 650 nm. Thereafter, in the similar manner to that of BD, disk discrimination is executed. Thus, as is shown in FIG. 5(b), the focus sweep operation is carried out upon optical disk loaded into the apparatus, with using the laser beam of wavelength 650 nm for DVD, in the similar manner as was mentioned above, thereby detecting the reflection upon the disk surface (see, the first reflection at time point “t3” in the figure) and the reflection (see, the second reflection at time point “t4” in the figure). However, the time period “T_{DVD}” mentioned above can be obtained, easily, as below, from a moving velocity “V” (mm/s) of the objective lens during the focus sweep operation thereof, in the similar manner to the above:
T_{DVD}=0.6/V

As is shown in FIG. 6(b), after detecting the reflection upon the disk surface (the first reflection at time point “t3” in the figure) and the reflection (the second reflection at time point “t4” in the figure) with using the laser beam of 650 nm for DVD, detection is made on whether the time difference, T (=t4−t3), falls within the predetermined time period (τ_{BD}) or not, thereby making discrimination thereupon. However, the spherical aberration generating portion (i.e., the beam expander) is set at the position corresponding to DVD, thereby enabling to detect the reflection light from the information recording surface of DVD. And, also the predetermined time period (τ_{DVD}: a slice level) mentioned above is set at such a time period (or, a value), in an extent, that it is sufficient for determining the medium to be other than DVD, since no reflection is generated upon the information recording surface even if elapsing the said time period, but that the objective lens will not reaches to the disk surface of CD due to continuation of the focus sweep operation mentioned above.

As was mentioned above, according to the present invention, in case when the optical disk loaded into the apparatus is determined not BD, first, then next, it is possible to discriminate on whether it is DVD or not, with certainty, with using the time period “T” between those two (2) reflection lights, which can be obtained from that disk while irradiating the laser beam for DVD.

<Process 3>

On the other hand, as a result of the determination mentioned above, but in case where the information recording surface (i.e., the second reflection) cannot be observed even after elapsing the predetermined time period (τ_{DVD}: the slice level) from the first reflection (at time point “t3”), it is possible to determine the disk loaded is CD. Alternately, however in the similar manner to the above-mentioned, it is also possible to determine that the disk loaded is CD, by further detecting the reflection upon the surface of the optical disk (i.e., the first reflection) and the reflection (i.e., the second reflection) upon the information recording surface thereof after elapsing the predetermined time period (for example, T_{CD}=τ_{CD}), while conducting the focus sweep operation upon the optical disk loaded into the apparatus with using the laser beam of wavelength 780 nm for CD. However, in this case, the predetermined time “T_{CD}” mentioned above can be obtained easily, from the moving velocity “V” (mm/s) of the objective lens during the focus sweep operation, in the similar manner.

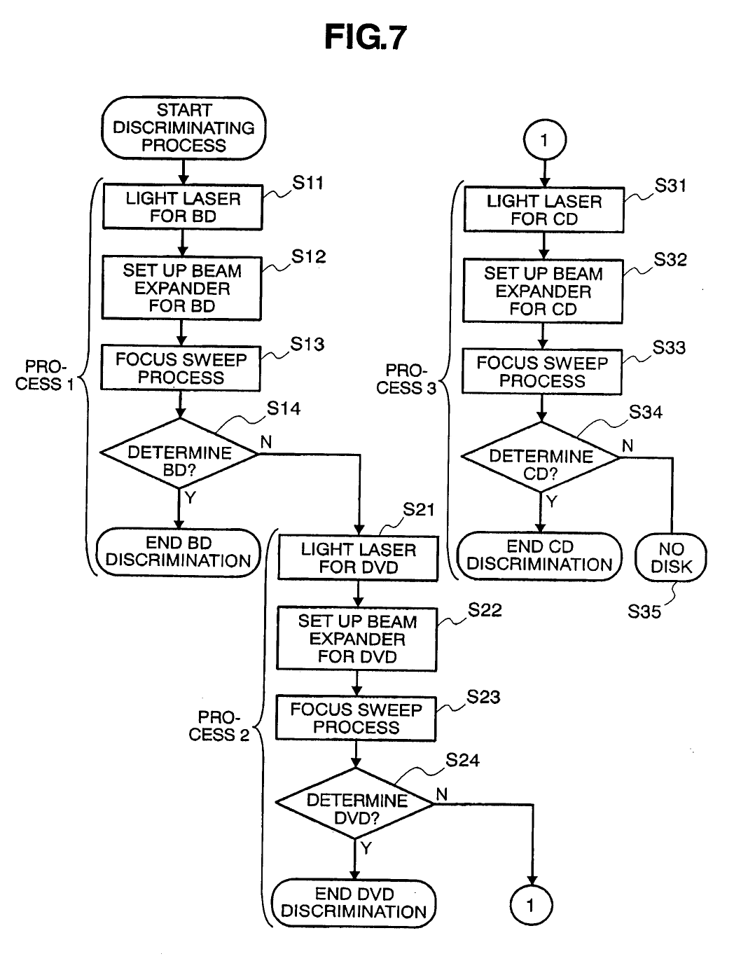

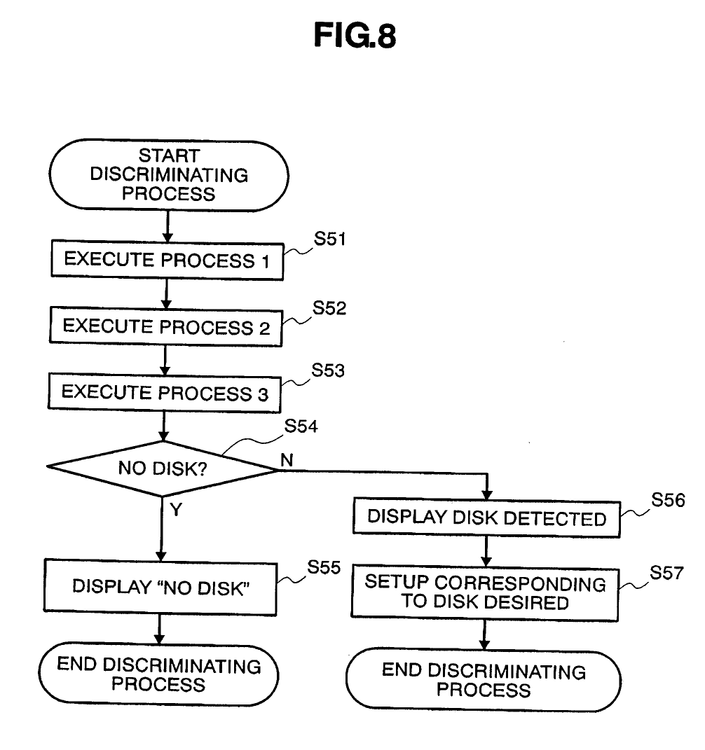

Following to the above, the details of the method for discriminating an optical disk (i.e., determining process) according to the present invention, the principle of which was explained in the above, by referring to a flowchart shown in FIG. 7 attached herewith. However, this optical disk discriminating method will be executed within the optical disk apparatus, the structures of which was shown in the above, and in more details thereof, it is stored within a memory in the form of software, to be executed automatically, by means of the μ-computer (CPU) 9, i.e., the control device, when said optical disk apparatus starts up or when it detects loading of the optical disk therein.

Thus, as is apparent from FIG. 7, when starting the determining process, the process 1 mentioned above is conducted, first. In more details, lighten-up is made upon the laser diode having wavelength 405 nm for BD (step S11) among those three (3) kinds of laser light sources of the optical disk apparatus (see FIG. 2 mentioned above). And, setup is made the spherical aberration generating portion (i.e., the beam expander) corresponding to BD (step S12), thereby executing the focus sweep process (operation) (step S13). Thereafter, after elapsing the setup time (τ_{BD}) mentioned above, determination will be made on the optical disk loaded whether it is BD or not (step S14), in accordance with the principle mentioned above, and as a result thereof, in case when being determined to be BD (“Y” in the figure), BD discrimination is completed while displaying the result thereof. On the other hand, when determined not to be BD (“N” in the figure), the process 2 mentioned above will be executed.

In this process 2, as was mentioned above, while stopping radiation of the laser beam having wavelength 405 nm for BD, lightening is made on the laser diode for radiating the laser beam of 650 nm for DVD (step S21), in the place thereof. However, in this instance, the position of the 3-wavelengths compatible objective lens is turned back to outside the surface of the optical disk, again. Thereafter, the spherical aberration generating portion (i.e., the beam expander) is set at the position corresponding to DVD (step S22), thereby executing the focus sweep process (operation) (step S23). And, after elapsing the setup time (τ_{DVD}) mentioned above, determination will be made on the optical disk loaded whether it is DVD or not (step S24), in accordance with the principle mentioned above, and as a result thereof, in case when being determined to be DVD (“Y” in the figure), DVD discrimination is completed while displaying the result thereof. On the other hand, when determined not to be DVD (“N” in the figure), further the process 3 below will be executed.

In this process 3, in the similar manner to the above, while stopping radiation of the laser beam having wavelength 650 nm for DVD, lightening is made on the laser diode for radiating the laser beam of 780 nm for CD (step S31), in the place thereof. However, in this instance, the position of the 3-wavelengths compatible objective lens is turned back to outside the surface of the optical disk, again, in the similar manner to the above. Thereafter, the spherical aberration generating portion (i.e., the beam expander) is set at the position corresponding to CD (step S32), thereby executing the focus sweep process (operation) (step S33). And, after elapsing the setup time (τ_{CD}) mentioned above, determination will be made on the optical disk loaded whether it is CD or not (step S34), in accordance with the principle mentioned above, and as a result thereof, in case when being determined to be CD (“Y” in the figure), CD discrimination is completed while displaying the result thereof. On the other hand, when determined not to be CD (“N” in the figure), then it is determined that no disk is loaded into the apparatus (S35), thereby completing the series of steps while displaying the result thereof.

As was mentioned above, with the determining method (or process) according to the present invention, since discrimination is executed, sequentially, on the optical disk loaded into the apparatus, in the order of length on the distance between the pickup and the disk surface at the focal position, it is possible to prevent the pickup from colliding upon the optical disk, and thereby to achieve the disk discrimination, easily and stably.

However, in the embodiment mentioned above, description was made about various kinds of optical disks, such as, so-called the next-generation DVD including BD, the DVD and CD, to be a target to be discriminated on the kind thereof; however, the determining method (or process) according to the present invention can be applied, further for other kinds of optical disks. The determining method (or process) mentioned above can be applied onto, for example, a hybrid disk (DVD/CD) called by “super audio CD”, being the hybrid disk of DVD and CD, and further a hybrid disk (BD/DVD) of BD and DVD.

An example will be shown of the determining method (or process) in case where the hybrid disk mentioned above is loaded, in FIG. 8 attached herewith. As is shown in the figure, when starting up the determining process, the process 1, the process 2 and the process 3 are executed, one by one (steps S51, S52 and S53), and thereafter, upon basis of the determination results in the respective steps, it is determined on whether no optical disk is loaded or not (step S54). As a result thereof, when determination is made that no optical disk is loaded (“Y” in the figure), the process is completed while displaying that the optical disk is not loaded into the apparatus (step S55).

On the other hand, as a result of determination in the step 54 mentioned above, in case where the optical disk is loaded therein (“N” in the figure), display is made upon the disk that is detected in the above (step S56). As a result of those processes 1 through 3, in case when being detected to be DVD, and at the same time CD, for example, then the disk is displayed to be the hybrid disk (i.e., the super audio CD). Or, when being detected to be BD and DVD, it is displayed to be the hybrid disk of BD and DVD (BD/DVD). Thereafter, setup is executed responding to the kind of disk that the user wishes (for example, it is inputted through the I/F portion 11 shown in FIG. 1).

As was mentioned above, according to the present invention, within the optical disk apparatus, applying the 3-wavelengths compatible objective lens thereby, thereby being operable with various kinds of optical disks, by using at least three (3) kinds of laser beams therein, each having different wavelength from one another, it is possible to discriminate the kind of disk, which is loaded into the apparatus, easily and with certainty, and to enable to avoid the objective lens from colliding upon the optical disk at that instance, with certainty.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A method for discriminating a kind of optical disk loaded therein, within an optical disk apparatus for recording or reproducing information onto/from said optical disk, by irradiating a light beam among plural numbers of laser beams generated from a light radiation source, each having wavelength different from each other, selectively, through a common objective lens upon an information recording surface of said optical disk, comprising the following steps of:
conducting focus sweep through said objective lens, upon said optical disk loaded into said optical disk apparatus, with using a laser beam from said light radiation source;
detecting a time between a disk surface and said information recording surface on said optical disk, from a reflection light which is obtained as a result of said focus sweep; and
discriminating the kind of said optical disk loaded into said optical disk apparatus, upon basis of the time between the reflections detected in the above.

2. The method for discriminating a kind of optical disk, as described in the claim 1, wherein discrimination of kind is executed, sequentially, upon said optical disk loaded into said optical disk apparatus, in descending order of distance defined between a position of said objective lens when the laser beam from said light radiation source is focused upon the information recording surface thereof through said objective lens and the disk surface of said optical disk loaded therein.

3. The method for discriminating a kind of optical disk, as described in the claim 2, wherein said optical disk loaded into said optical disk apparatus is one of those, including at least a CD, a DVD, and a next-generation DVD therein.

4. The method for discriminating a kind of optical disk, as described in the claim 3, wherein the discrimination of kind of the optical disk is executed, in order that the next-generation DVD and then the DVD.

5. The method for discriminating a kind of optical disk, as described in the claim 4, wherein a laser beam of wavelength 405 nm and a laser beam of wavelength 650 nm are used when executing the discrimination of kind of the optical disk, in the order that the next-generation DVD and then the DVD.

6. The method for discriminating a kind of optical disk, as described in the claim 3, further comprising a step of conducting discrimination on that the optical disk loaded into said optical disk apparatus is the CD, with using a laser beam of wavelength 780 nm, after executing the discrimination of kind of the optical disk in the above, in the order that the next-generation DVD and then the DVD.

7. An optical disk apparatus for recording or reproducing information onto/from an optical disk, comprising:
a light radiation source for generating plural numbers of laser beams from, each having wavelength different from each other;
a common objective lens for irradiating the plural numbers of laser beams through it, selectively, from said light radiation source upon an information recording surface of said optical disk; and
a controller for conducting focus sweep through said objective lens, upon said optical disk loaded into said optical disk apparatus, with using a laser beam from said light radiation source, detecting a time between a disk surface and said information recording surface on said optical disk, from a reflection light which is obtained as a result of said focus sweep, and discriminating the kind of said optical disk loaded into said optical disk apparatus, upon basis of the time between the reflections detected in the above.

8. The optical disk apparatus, as described in the claim 7, wherein said controller execute discrimination of kind, sequentially, upon said optical disk loaded into said optical disk apparatus, in descending order of distance defined between a position of said objective lens when the laser beam from said light radiation source is focused upon the information recording surface thereof through said objective lens and the disk surface of said optical disk loaded therein.

9. The optical disk apparatus, as described in the claim 8, wherein said light radiation source for generating the plural number of laser beams different in the wavelength thereof is able to generate a laser beam of wavelength 405 nm, a laser beam of wavelength 650 nm, and a laser beam of wavelength 780 nm therefrom.

10. The optical disk apparatus, as described in the claim 8, wherein said optical disk loaded into said optical disk apparatus is one of those, including at least a CD, a DVD, and a next-generation DVD therein, and said controller discriminates the kind of the optical disk, at least, in order that the next-generation DVD and then the DVD.
